(19) United States
(12) Patent Application Publication
(10) Pub. No.: US 2022/0266209 A1
(43) Pub. Date: Aug. 25, 2022

(54) LARGE SCALE MIXING SYSTEMS, DEVICES, AND METHODS

(71) Applicant: Apeel Technology, Inc., Goleta, CA (US)

(72) Inventors: Gregory Faust, Goleta, CA (US); Cody Hegel, Goleta, CA (US); Matthew Dominick Gaudioso, Goleta, CA (US); Erich Brodbeck, Goleta, CA (US)

(21) Appl. No.: 17/677,957

(22) Filed: Feb. 22, 2022

Related U.S. Application Data
(60) Provisional application No. 63/152,050, filed on Feb. 22, 2021.

(51) Int. Cl. B01F 23/50; B01F 23/53; B01F 23/70; B01F 27/91; B01F 27/93; B01F 27/113; B01F 27/115; B01F 27/17; B01F 27/271; B01F 35/92; B01F 35/21; B01F 35/213; B01F 35/221

(52) U.S. Cl. CPC B01F 23/59; B01F 23/53; B01F 23/56; B01F 23/51; B01F 23/711; B01F 27/911; B01F 27/93; B01F 27/113; B01F 27/1153; B01F 27/17; B01F 27/2712; B01F 35/92; B01F 35/2115; B01F 35/2113; B01F 35/213; B01F 35/2215; B01F 35/2217; B01F 35/2218; B01F 35/2132; B01F 2035/99

(57) ABSTRACT

The subject matter of this specification can be embodied in, among other things, a mixing system that includes a heating assembly configured to heat liquid, and a mixing assembly including a tank defining a cavity and configured to retain liquid, an inlet in fluidic communication with the cavity and configured to receive liquid from the heating assembly, a mixing impeller assembly configured to mix contents of the cavity, an actuator configured to actuate the mixing impeller assembly to mix contents of the cavity, and an outlet in fluidic communication with the cavity and having a valve configured to selectively prevent and permit egress of contents of the cavity.

### CROSS-REFERENCE TO RELATED APPLICATIONS

This application claims the benefit of priority to U.S. Application No. 63/152,050, filed on Feb. 22, 2021, the contents of which are hereby incorporated by reference.

### TECHNICAL FIELD

This instant specification relates to mixing systems, such as industrial scale mixing systems for the preparation of protective food coatings.

### BACKGROUND

Common products, such as food products, agricultural products, and fresh produce, are susceptible to degradation and decomposition (i.e., spoilage) when exposed to the environment. Product degradation can occur via abiotic means as a result of evaporative moisture loss from an external surface of the agricultural products to the atmosphere, oxidation by oxygen that diffuses into the agricultural products from the environment, mechanical damage to the surface, and/or light-induced degradation (i.e., photodegradation). Furthermore, biotic stressors, such as bacteria, fungi, viruses, and/or pests, can also infest and decompose the agricultural products.

On some commercial packing lines, agricultural products may be treated, for example, with waxes which preserve the agricultural products, with sanitizing agents which reduce or eliminate bacteria or other biotic stressors, and/or with solutions that can form protective coatings over the products. In some processes, equipment which automates various operations or more easily facilitates carrying out the processes can be beneficial.

### SUMMARY

In general, this document describes systems and techniques for mixing, such as industrial scale mixing of protective coatings for food or other products. Various systems described herein facilitate efficient and consistent mixing of large volumes of material. For example, some systems and techniques described in this document provide a mixing system to mix constituents of a coating material. In some optional embodiments, the constituents include a powder and a solvent, such as heated water, ethanol, buffer solutions, and the like. The mixing system can be used to prepare emulsions of protective coating material at a relatively large scale, which can subsequently be applied to surfaces of products for form a protecting for application to large quantities of product.

In some optional embodiments, mixing systems and techniques described herein facilitate preparation of a coating agent that can be applied to form a protective coating on food products. For example, the coating agent forms a protective coating that can slow a rate of oxygen and carbon dioxide diffusion while holding in moisture, slowing cellular respiration and oxidation and/or limiting water loss. Such coatings and provide a prolonged shelf life that enhances the desirability of food products over an extended period of time and/or reduces food waste. In some implementations, the biomolecular mechanisms underlying these physical consequences can be driven, at least in part, by a reduction or delay in the mediated ripening response of the produce, by retaining moisture inside the produce, and by protecting the produce from oxygen in the ambient air. By retaining moisture in treated produce, ABA metabolism and signaling can be reduced and/or delayed, leading to a longer time to ripening for that piece of produce.

In some embodiments, the system includes a heating assembly to heat water or other liquid, a mixing assembly to mix heated water with one or more coating composition materials, and a controller to control one or more operations of the heating assembly and/or mixing assembly. The heating assembly can be configured to deliver a desired volume of heated water or liquid to the mixing assembly. The mixing assembly configured to impart a predetermined shear force to contents of the mixing assembly to effectively and consistently prepare a mixture. Various systems and techniques described herein facilitate powdered coating concentrates to be mixed with water (e.g., emulsified) at high, industrial-scale volumes. Some optional embodiments described herein facilitate mixing water-based solutions that include a monoglyceride and a fatty acid salt.

In an example aspect, a mixing system includes a heating assembly configured to heat liquid, and a mixing assembly including a tank defining a cavity and configured to retain liquid, an inlet in fluidic communication with the cavity and configured to receive liquid from the heating assembly, a mixing impeller assembly configured to mix contents of the cavity, an actuator configured to actuate the mixing impeller assembly to mix contents of the cavity, and an outlet in fluidic communication with the cavity and having a valve configured to selectively prevent and permit egress of contents of the cavity.

Various embodiments can include some, all, or none of the following features. The mixing impeller can be located below the pumping impeller. The mixing impeller can be configured to generate relatively higher shear than the pumping impeller during operation. The mixing impeller can have a mixing impeller diameter and the tank can have a tank inner diameter, and the mixing impeller diameter can be between 10% and 90% of the tank inner diameter. The mixing impeller diameter can be between 6 in and 36 in. The mixing impeller can be configured as a high shear disc. The tank inner diameter can be measured at the height of the mixing impeller. The pumping impeller can be configured to provide at least 50 turnovers per minute of contents of the tank at an impeller rotational speed between 300 and 5000 revolutions per minute. The mixing impeller can be configured as a three-blade propeller having a diameter between 6 and 36 inches. The rotor shaft can be configured as split shaft having a first section having an axially threaded male portion having a first thread, and a second section having a female portion having a second thread configured to threadedly mate with the first thread such that the first thread is entirely concealed within the second section. The mixing impeller assembly can include a rotor shaft, a pumping impeller configured to be rotated by the rotor shaft, and a mixing impeller configured to be rotated by the rotor shaft. The actuator can be configured to rotate the mixing impeller between 300 RPM and 5000 RPM. The actuator can be configured to rotate the mixing impeller to generate a mixing impeller tip speed between 6 m/s and 14 m/s. The mixing impeller can be separated from the pumping impeller along the rotor shaft by a predetermined fixed distance. The fixed distance can be between 50% and 98% a height of the tank. The mixing assembly may exclude a heating element. The tank may exclude a heating element configured to heat contents of the tank. The heating assembly can be configured to output water to the tank at a temperature between 50° C. and 100° C. The mixing system can be configured to mix a batch having a volume between 80 L and 1500 L. The mixing system can be configured to mix the batch in less than 25 min. A time to fill the tank with hot water from the heating system can be less than 18 min. The heating system can include a collection of heating modules arranged in parallel and configured to simultaneously output heated liquid to the tank. The mixing assembly can be configured to generate a homogenous emulsion at a concentration of greater than 50 grams/liter in a mixing duration of less than 25 minutes. The mixing system can include a portable platform, wherein the heating assembly is affixed to and arranged upon the portable platform. The heating assembly can include a collection of heating modules configured to heat liquid. The collection of heating modules can be a collection of on-demand water heaters. The mixing system can include a portable platform, wherein the mixing assembly is affixed to and arranged upon the portable platform. The mixing system can include at least one of a temperature sensor configured to measure temperature of contents of the cavity, a turbidity sensor configured to measure turbidity of contents of the cavity, and a pressure sensor configured to measure a level of contents of the cavity. The mixing assembly can also include an access port configured to provide access to the cavity.

In another example aspect, a method of mixing includes at least partly filling a tank with a liquid, adding a powdered additive to the liquid through an access port of the tank, and mixing the powdered additive into the liquid to form an emulsion.

Various implementations can include some, all, or none of the following features. The method can include determining a level of homogenization of the emulsion, and terminating the mixing, based on the determining. The method can include determining a level of homogenization of the emulsion, and removing, based on the determining, at least a portion of the emulsion from the tank. The method can include heating, by a heating assembly, the liquid before at least partly filling the tank through an inlet in fluidic communication with the tank and configured to receive the liquid from the heating assembly. The heating assembly can be configured to output water to the tank at a temperature between 50° C. and 100° C. Mixing the powdered additive into the liquid to form a slurry can include mixing, by a mixing impeller assembly comprising a rotor shaft, a pumping impeller configured to be rotated by the rotor shaft, and a mixing impeller configured to be rotated by the rotor shaft. The mixing impeller can be located below the pumping impeller. The mixing impeller can be configured to generate relatively higher shear than the pumping impeller during the mixing. The mixing impeller can have a mixing impeller diameter and the tank has a tank inner diameter, and the mixing impeller diameter is between 10% and 90% of the tank inner diameter. The tank inner diameter can be measured at the height of the mixing impeller. The mixing impeller diameter can be between 6 in and 36 in. The mixing impeller can be configured as a high shear disc. The mixing impeller can be configured as a three-impeller propeller having a diameter between 6 and 36 inches. The pumping impeller can be configured to provide at least 50 turnovers per minute of contents of the tank at an impeller rotational speed between 300 and 5000 revolutions per minute. The method can include assembling a first section to a second section to form the rotor shaft, wherein the rotor shaft is configured as split shaft, the first section has an axially threaded male portion having a first thread, and the second section has a female portion having a second thread configured to threadedly mate with the first thread such that the first thread is entirely concealed within the second section. Mixing the powdered additive into the liquid to form an emulsion can include turning over the emulsion in the tank at a rate of least 50 times per minute. The slurry in the tank can be turned over by rotating a pumping impeller at between 300 and 5000 revolutions per minute. Mixing the powdered additive into the liquid to form an emulsion can include rotating a high shear disc. The high shear disc can be rotated at between 300 and 5000 revolutions per minute. Determining a level of homogenization of the slurry can include determining, based on a signal from a turbidity sensor, a level of turbidity of the liquid in the tank. The method can also include determining, based on a signal from a pressure sensor, a level of the liquid in the tank. The method can include determining, based on a signal from a temperature sensor, a temperature of the liquid in the tank. The method can include not heating the liquid with a heating element. The tank can exclude a heating element configured to heat the liquid in the tank. A time to fill the tank with the liquid can be less than 18 min.

In another example aspect, a mixing system includes means for heating a liquid, and means for mixing a powder into the heated liquid to form an emulsion.

Various embodiments can include the following feature. The mixing system can include means for storing the emulsion.

In another example aspect, a mixing assembly includes a liquid inlet, a powder inlet, an outlet, a heating assembly configured to heat liquid received through the liquid inlet, a powder feeder configured to urge movement of a powdered additive received through the powder inlet, a disperser assembly configured to mix the powdered additive from the powder feeder and liquid received from the heating assembly into an emulsion, and a controller configured to control the heating assembly to heat liquid by a predetermined amount at a predetermined flow rate, control the powder feeder to provide the powdered additive to the dispenser assembly at a predetermined rate, and control the disperser assembly to provide the emulsion at a predetermined concentration at a predetermined flow rate.

Various embodiments can include some, all, or none of the following features. The mixing assembly can include a flow regulator configured to regulate fluid flow through the liquid inlet or the outlet at a predetermined flow rate. The mixing assembly can exclude a mixing tank. The disperser assembly can include a stator having an axial cavity defined therethrough, and having a plurality of first teeth arranged concentrically about a periphery of the cavity, and a rotor arranged concentrically within the cavity and having a plurality of second teeth arranged about an outer periphery of the rotor proximal the first teeth, wherein the rotor is configured to rotate within the cavity relative to the stator, and emulsify the powdered additive and liquid received within a radial interior of the rotor as the powdered additive and liquid are urged through the second teeth and the first teeth. The predetermined concentration can be between 1 g/L and 50 g/L. The predetermined flow rate can be between 10 L/min and 360 L/min. The heating assembly can have a heating capacity between 100,000 btu/hr and 1,200,000 btu/hr.

In another example aspect, a method of mixing includes providing a liquid at a predetermined liquid flow rate, heating the liquid to a predetermined temperature, providing a powdered additive at a predetermined powder flow rate, dispersing the powdered additive into the heated liquid to form an emulsion having a predetermined concentration, and providing the emulsion at a predetermined output rate.

Various implementations can include some, all, or none of the following features. The liquid flow rate can be between 10 L/min and 360 L/min. The predetermined temperature can be between 50° C. and 100° C. The powder flow rate can be between 10 g/min and 18,000 g/min. The predetermined concentration can be between 1 g/L and 50 g/L. The predetermined output rate can be between 10 L/min and 360 L/min.

The systems and techniques described here may provide one or more of the following advantages. First, some embodiments described herein facilitate mixing of solutions for food processing at an industrial-scale. Relatively large volumes of coating composition can be efficiently mixed at a predetermined concentration. For example, the mixing assembly can include one or more mixing impellers configured to impart a predetermined shear and/or turnover the entire contents of a mixing tank, to prepare the coating composition in a relatively short processing time. Some embodiments described herein facilitate efficient mixing of highly concentrated coating composition components (e.g., such as concentrates in powdered form), and/or high loading of coating compositions in a solvent.

Second, some embodiments described herein facilitate efficient preparation of an emulsion from a solvent (e.g., water), monoglyceride, and fatty acid salt. A mixing assembly can be configured to impart a high shear force to generate an emulsion having predictable characteristics in a time and energy efficient manner.

Third, some embodiments described herein facilitate effective mixing at a location where the coating composition is applied, such as a product processing or packing facility. The mixing system can heat a solvent (e.g., water), and mix with one or more components of a coating composition, to rapidly prepare the coating composition in bulk quantities while occupying a relatively small foot print. Alternatively or additionally, some embodiments optionally facilitate fluidic communication with application equipment, such that the mixed coating composition can be readily delivered to the application equipment (e.g., without requiring transportation between facilities).

Fourth, some embodiments described herein facilitate automation of one or more operations of a mixing procedure. For example, some embodiments described herein include a controller configured to control a timing and sequence of heating a solvent (e.g., water), delivering solvent to a mixing tank, distributing one or more coating composition components into the mixing tank, operation of a mixing impeller (e.g., speed, rotational profile, etc.), and transfer of mixed coating composition from the mixing tank. One or more steps may be controlled based on predetermined parameters and/or feedback loops based on input from one or more sensors, to facilitate efficient and consistent mixing that yields a highly predictable coating composition.

Fifth, some embodiments described herein facilitate efficient mixing while reducing cleaning and/or maintenance operations of the mixing assembly. For example, in some optional embodiments, an interior of the mixing tank may be composed primarily of large, exposed surfaces that are accessible for cleaning, and have relatively few moving parts with inaccessible interfaces. In some embodiments, the mixing tank does not include a heating element exposed to the contents of the mixing tank, or does not include a heating element at all, reducing the need for cleaning operations associated with a heating element of the mixing assembly.

Sixth, the system can be constructed as a portable or transportable assembly. For example, some embodiments include a heating assembly and/or mixing assembly that can be pre-fabricated and transported to a packing facility or other location for use. Such a configuration can facilitate rapid deployment, installation, and operation.

Seventh, some embodiments described herein facilitate effective mixing and packaging of the mixture at a first location, and then transporting the mixture to another location where the coating composition is applied, such as a product processing or packing facility. The mixing system can heat a solvent (e.g., water), and mix with one or more components of a coating composition, to rapidly prepare the coating composition in bulk quantities while occupying a relatively small foot print.

The details of one or more implementations are set forth in the accompanying drawings and the description below. Other features and advantages will be apparent from the description and drawings, and from the claims.

### DESCRIPTION OF DRAWINGS

FIG. 1 shows an example of a system for industrial mixing.

FIG. 2 schematic diagram of the example system of FIG. 1.

FIGS. 3A and 3B show an example heating assembly of the system of FIG. 1.

FIG. 4 shows an example mixing assembly of the system of FIG. 1.

FIG. 5 shows a sectional view of the example mixing assembly of FIG. 4.

FIG. 6 shows an enlarged view of example outlet components shown in FIG. 5.

FIG. 7 shows an enlarged view of an example mixing impeller assembly.

FIG. 8 shows a sectional view of an example rotor shaft.

FIG. 9 shows a block diagram of an example system for continuous industrial mixing.

FIG. 10 shows a schematic diagram of an example system for continuous industrial mixing.

FIGS. 11A-11C show assembled and disassembled views of an example mixing impeller assembly for continuous industrial mixing.

FIG. 12 is a flow diagram of an example startup process for a system for industrial mixing.

FIG. 13 is a flow diagram of an example batch mixing process for a system for industrial mixing.

FIG. 14 is a flow diagram of an example continuous mixing process for a system for industrial mixing.

FIG. 15 is a flow diagram of an example shutdown process for a system for industrial mixing.

FIG. 16 is a flow diagram of an example cleaning process for a system for industrial mixing.

### DETAILED DESCRIPTION

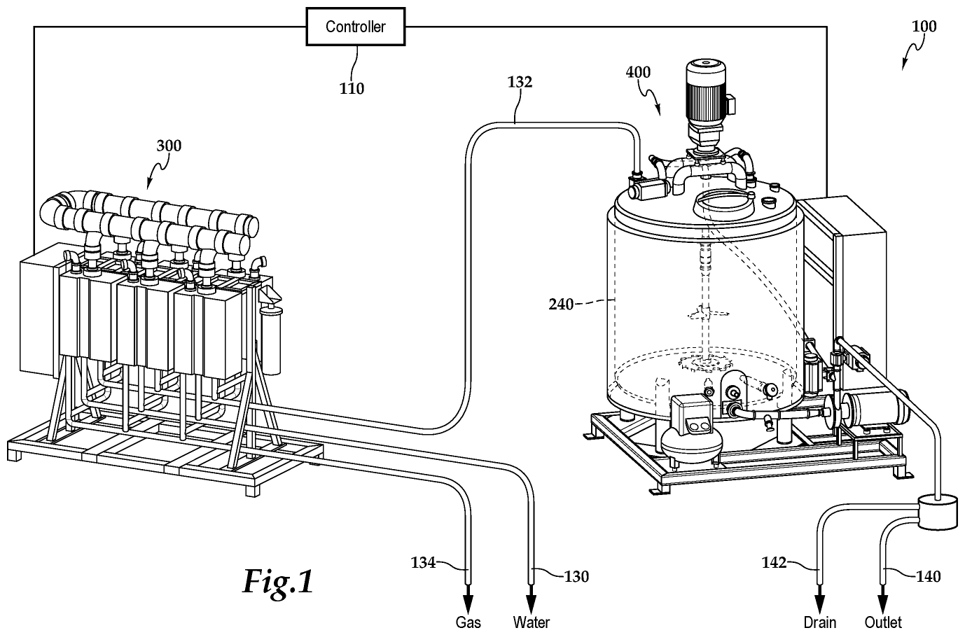

FIG. 1 shows an example mixing system 100. The system 100 includes a controller 110, a heating assembly 300, and a mixing assembly 400. The heating assembly is configured to output a heated solvent (e.g., water) to the mixing assembly 400, which in turn mixes the solvent with one or more constituents to prepare a final composition, such as a product coating composition. The controller 110 is configured to control one or more operations of heating assembly 300 and/or mixing assembly 400.

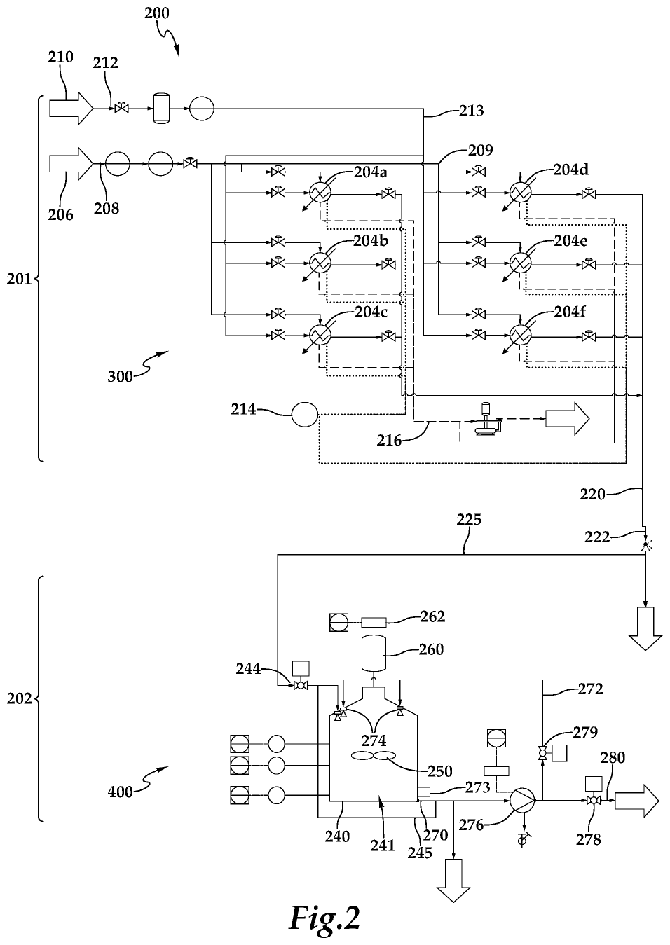

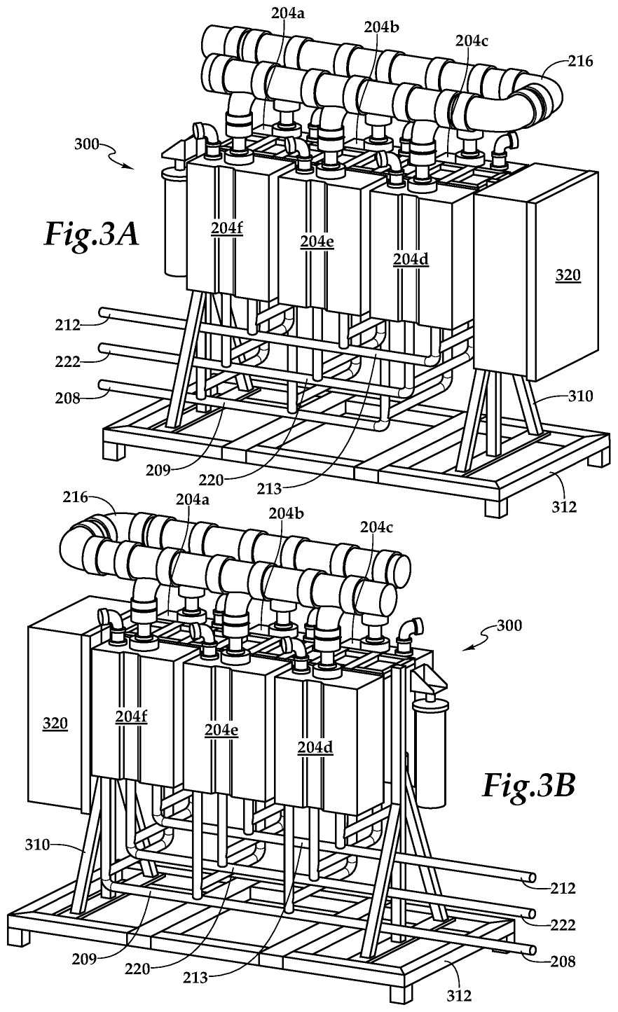

The heating assembly 300 is configured to heat water from a cold (e.g., unheated) water conduit 130, and provide the heated water to the mixing assembly 400, directly or indirectly, via a hot conduit 132. The heating assembly 300 can be powered by fuel (e.g., natural gas) received through a fuel conduit 134. Alternatively or additionally, the heating assembly 300 can be powered by electricity. The heating assembly 300 is described in more detail with reference to FIGS. 2 and 3 below.

The mixing assembly 400 is configured to receive heated liquid from the hot conduit 132 into an internal tank 240 that defines a volume of contents to be mixed. One or more constituents (e.g., such as a concentrated powder) is added to the internal tank, and the mixture is agitated to form an emulsion, for example. The mixing assembly is configured to selectively pump the contents of the tank to an outlet conduit 140 (e.g., to fill totes/storage tanks or to be directed to one or more applicators for application to products) or a drain conduit 142 (e.g., for flushing, reclamation, or cleaning purposes). The mixing assembly 400 is described in more detail with reference to FIGS. 2 and 4-8 below.

FIG. 2 is a schematic diagram of an example mixing system, such as a mixing system having one or more features of system 100 of FIG. 1. The diagram 200 includes sub-diagrams for two interconnected main components, including a heater assembly 201 (e.g., such as heater assembly 300 described with reference to FIG. 1) and a mixing assembly 202 (e.g., such as a mixing assembly 400 described with reference to FIG. 1).

The heater assembly 201 includes a plurality of heating units, such as six heating units 204a-204f. Each of the heating units 204a-204f is configured to receive fuel (e.g., natural gas, liquid petroleum) from a fuel manifold 209 connected to a fuel supply 206 at a fuel inlet 208 (e.g., connected to the fuel conduit 134). Alternatively or additionally, the heating units 204a-204f may electrically powered by an electrical source (e.g., in which inlet 208 and the manifold 209 can be an electrical circuit).

Each of the heating units 204a-204f is configured to receive water from water manifold 213 connected to a water supply 210 at a water inlet 212 (e.g., connected to the cold water conduit 130 (FIG. 1)). In some embodiments, the water supply can be provided directly from a water main. In some embodiments, the water supply 210 includes a water treatment apparatus (e.g., filtering system, deionizer, distiller) located upstream of heating units 204a-204f.

Each of the heating units 204a-204f is configured to heat water from the water manifold 213, based on control signals received from a temperature controller 214. The heated water is provided to a water manifold 220 that is fluidically connected to a water conduit 225 (e.g., the hot water conduit 132 (FIG. 1)) at a water outlet 222.

In an example embodiment, the heating units 204a-204f are on-demand (e.g., tankless) water heaters. The heating assembly 201 includes multiple heating units 204a-204f that can be selected to collectively provide a predetermined output of heated water. Multiple heating units 204a-204f arranged in parallel increase the flow rate that can be achieved at a set temperature, while occupying a relatively small footprint. In various example embodiments, heating units 204a-205f can include one or more storage tank water heaters, industrial boilers, solar water heaters, geothermal heaters, heat pumps, exhaust manifolds, etc.

Still referring to FIG. 2, a schematic diagram of example mixing assembly 202 (e.g., such as mixing assembly 400 described with reference to FIG. 1) is shown. The mixing assembly 202 includes a tank 240 that defines a cavity 241. The tank is configured to receive water from the water conduit 225, the flow of water from the water conduit 225 to the tank 240 can be controlled by a valve 244.

In some embodiments, the water conduit 225 can be fluidically connected to one or more mixing assemblies. For example, the heating assembly 201 can provide water to the mixing assembly 202 and one or more additional mixing assemblies. While the mixing assembly 202 is in use and not receiving water, the heating assembly 201 can heat and/or direct water for one or more of the additional mixing assemblies. Such a configuration can reduce the space to accommodate system 200 while promoting high system throughput. Similarly, such a configuration can reduce operational idle time of heating assembly 201.

Mixing system 202 includes a mixing impeller assembly 250 configured to mix or otherwise agitate the contents of the tank 240. The mixing impeller assembly 250 is actuated by, for example, an electric motor 260 that is controlled by a variable frequency drive (VFD) controller 262. In some implementations, the VFD controller 262 is configured to cause the mixing impeller assembly 250 to rotate at about 250 to 1400 revolutions per minute, 400 to 1000 revolutions per minute, 500 to 700 revolutions per minute, or between 600 and 900 revolutions per minute. Such rotational speeds can produce sufficient energy (e.g., shear force) and velocity (e.g., shear rate) to efficiently and predictably mix the contents of the tank 240. In some implementations, such rotational speeds can reduce or limit undesirable cavitation and/or air inclusion from the top surface.

The mixing assembly 202 is configured to receive a powder and/or other additives to be mixed in the tank 240. Rotation of the mixing impeller assembly 250 stirs and mixes the contents of the tank 240. Additional mixing of the tank contents is provided by recirculation of the mixture from an outlet 270 (e.g., near a floor of the tank 240) through a recirculation conduit 272, to a collection of nozzles 274 (e.g., arranged near a top of the tank 240). The recirculation flow is urged by a pump 276 (e.g., a diaphragm pump, a centrifugal pump), and is directed to the recirculation conduit 272 by opening a valve 278 and closing a valve 279. In some embodiments, the outlet 270 can be fluidically connected to a secondary outlet, for example, in connection with an application pump configured to apply the mixture to a product (e.g., to spray the mixture on product as a protective coating).

In some embodiments, heating of the mixture can occur within the recirculation conduit 272 of the mixing tank. For example, the mixing assembly includes a heater assembly associated with the recirculation conduit 272 configured to heat recirculating fluids. As the fluid circulates through the recirculation conduit 272, a temperature of the fluid is elevated by the heater assembly. The temperature can be controlled by controlling the heat output of the heater assembly and/or by controlling circulation of fluid (e.g., flow rate, cycles, etc.) through the recirculation conduit 272.

The mixing assembly 202 includes a turbidity sensor 273 (e.g., based on spectroscopy, visible light, infrared light, ultraviolet light). The turbidity sensor is configured to measure the turbidity (e.g., homogeneity, consistency) of the emulsion in the tank 240. In some embodiments, the turbidity of the emulsion can be based on the homogeneity and/or consistency of the emulsion. In some embodiments, the turbidity of the emulsion can be based on a calibrated or predetermined properties of the mixture. For example, the turbidity sensor can output a signal indicative of a clarity, transparency, color, etc. of the emulsion, indicating the emulsion has reached a predetermined level of mixing and/or is substantially free of large particles. In some embodiments, the operation of the mixing assembly can be at least partly based on feedback from the turbidity sensor 273. For example, the turbidity sensor 273 can be used to determine when the content of the tank 240 has been mixed to a predetermined concentration or consistency. In some embodiments, the turbidity sensor 273 can be located directly in the tank 240, in the recirculation conduit 272, or in any other appropriate location in the mixing assembly 202. Alternatively or additionally, one or more sensors (e.g., spectroscopy, visible light, infrared light, ultraviolet light) are included to detect one or more characteristics of the emulsion.

The tank 240 can be drained or emptied by opening the valve 278, closing the valve 279, and activating the pump 276 to flow the mixture to an outlet 280. In some implementations, the outlet 280 can provide the flow to a drain (e.g., the drain 142, for flushing or cleaning the tank 240). In some implementations, the outlet 280 can provide the flow to a container (e.g., the pump 276 can be used to fill a portable tote tank that can be transported to another location for use), or to an application output (e.g., the outlet 140, connected to a sprayer assembly configured to apply the mixture to produce as a protective coating).

The pump 276 is configured with a food-safe design. In some embodiments, the pump 276 can be powered by a motor having a capacity of about 3 hp, and configured to flow at a rate of about 148 GPM. In some embodiments, the pump 276 can include a low point drain, a sample valve, and/or a capped tee (e.g., for connection to a controlled droplet applicator).

The mixing assembly 202 also includes a bypass conduit 245. In some implementations, the bypass conduit can be configured (e.g., by a collection of valves, not shown) to route liquid flow around the mixing tank 240 (e.g., for flushing or cleaning operations).

FIGS. 3A and 3B are rear and front side views of the example heating assembly 300 of the system of FIG. 1. The heating assembly 300 includes heating units 204a-204f, fuel inlet 208, fuel manifold 209, water inlet 212, water manifold 213, exhaust manifold 216, water manifold 220, and water outlet 222.

The heating units 204a-204f are configured as safe for use with drinking water. For example, heating units 204a-204f may be certified as compliant for use with drinking water according to NSF 61 and 372 standards, or equivalent. In various example embodiments, heating units 204a-204f have a rated heating capacity between about 100,000 btu/hr to 1,200,000 btu/hr, 150,000 btu/hr to 600,000 btu/hr, or about 200,000 btu/hr. In an example embodiment, heating assembly 300 includes six heating units 204a-204f. A plurality of heating units, such as six heating units 204a-204f can reduce filling time by increasing flow rate. Alternatively or additionally, the use of a plurality of heating units 204a-204 can improve overall system reliability by providing redundancy. The heating assembly 300 remains operational in the event one or more heating unit 204a-204f are not used during a filling operating. In some embodiments, the use of a selected number of heating units does not substantially change the overall power/energy consumption of heating assembly 300 at a given heating rate.

In some embodiments, the heating assembly 300 can include a filter (e.g., a 5 micron filter) configured to filter water entering the water inlet 212 or the water manifold 213. A filter may facilitate connection to an existing water supply, such as a pre-existing water main at an installation location. A filter may thus promote a consistent and predictable mixed composition that is impacted less by water characteristics of the installation location. In some embodiments, the water manifold 220 can be insulated to retain heat.

The heating assembly 300 can include a human-machine interface (HMI), for example, to display a readout (e.g., at a human-machine interface or other type or local or remote display) of an output of a hot water temperature sensor arranged in the water manifold 220 and/or one or more parameters of heating assembly 300. In some embodiments, one or more of the water inlet 212, the water manifold 213, the water manifold 220, and/or the water outlet 222 can be made of food-grade (e.g., stainless steel) solid or flexible conduit. In some embodiments, the heating assembly 300 can include a fuel pressure regulator and/or indicator.

The heating assembly 300 includes a support structure 310. In an example embodiment, various components of heating assembly 300, including heating units 204a-204f, are affixed to a support structure 310. The support structure 310 includes a support base 312 that holds components of the heating assembly upright. Other components of heating assembly 300, such as an electrical enclosure 320 (e.g., to house the example temperature controller 214 and associated electrical components such as an HMI, switches, circuit breakers, lockouts), fluid conduits, sensors, valves, pressure regulators, and other appropriate components associated with water heating, are also affixed to the support structure 310. In some embodiments, the heating assembly 300 can be a portable, modular assembly (e.g., a heating skid) that can make the heating assembly 300 easier to manufacture, transport, install, and reconfigure as needed. For example, power components of the entire heating assembly 300 may be connected to a single power port or cord, to provide a single point to quickly connect the heating assembly 300 to a power bus or outlet.

In use, the heating assembly is configured to receive cold water at a first temperature and output heated water to the tank at a second temperature at a predetermined rate (e.g., liters per minute). For example, the heating assembly is configured to receive cold water at a first temperature of between about 10° C. and 30° C., 15° C. and 25° C., or about 20° C., and output heated water to the tank at a second temperature between 50° C. and 100° C., 60° C. and 90° C., or about 80° C. at a rate of about 10 liters per minute to 360 liters per minute, 30 liters per minute to 180 liters per minute, or about 60 liters per minute. Such parameters can facilitate efficient filling of the mixing tank, and promote high overall production rates. For example, for a batch volume of 900 L, a flowrate from the heating assembly 300 of 60 liters per minute at an incoming water temp of 20° C. can output 900 liters of heated water into the mixing tank in about 15 minutes. In various example embodiments, the heating assembly 300 can be configured to fill the mixing assembly 400 with water heated from room or tap temperature to operational temperature in about 20 minutes or less, 18 minutes or less, 15 minutes or less, 12 minutes or less, 10 minutes or less, or less than 8 minutes.

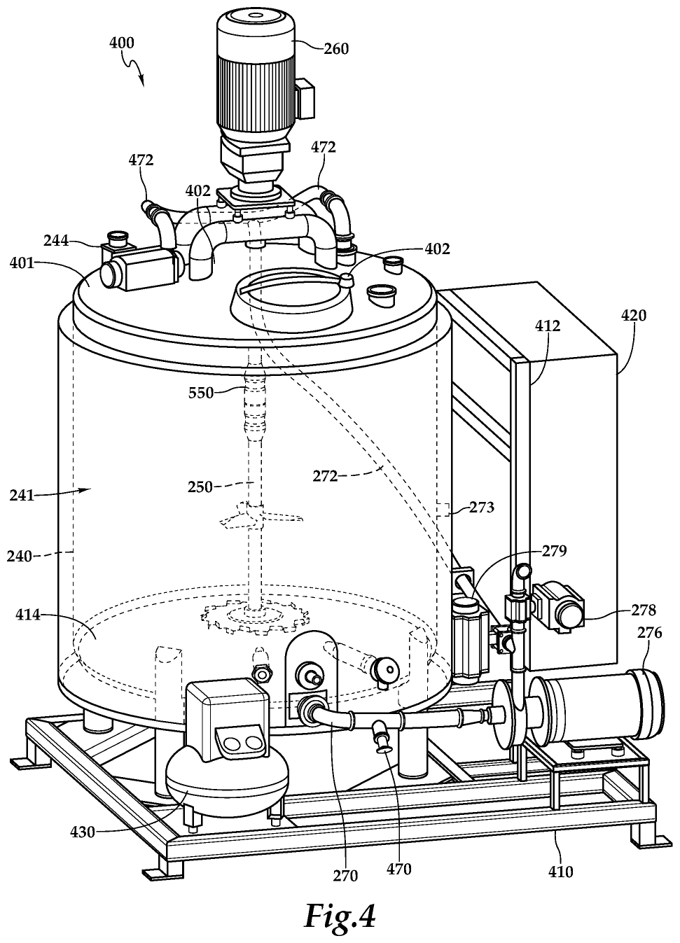

FIG. 4 shows the example mixing assembly 400 of the system of FIG. 1. Mixing assembly 400 includes the tank 240, the cavity 241, the valve 244, the mixing impeller assembly 250, the electric motor 260, the outlet 270, the recirculation conduit 272, the pump 276, the valve 278, the valve 279, and the outlet 280. The cavity 241 is configured to hold a fluid volume from about 250 L to about 900 L. In some embodiments, the tank 240 can be a 3A, FDA-certified tank. In some embodiments, the valves 278, 279, and/or 244 can be pneumatically actuated ball, butterfly, or diaphragm valves.

The tank 240 includes welded, domed lid 401 with a hatch 402 that is configured to provide access to the cavity 241. In use, the hatch 402 can be opened in facilitate addition of a powder or other form of additive to the tank 240 and/or to clean or service the interior components of the tank 240.

Mixing impeller assembly 250 operates to agitate the contents of the tank 240. For example, a mixing impeller assembly 250 rotates at a selectable speed to stir/mix the contents of the tank 240. As described in greater detail herein, mixing impeller assembly 250 may include a plurality of mixing impellers or impeller portions. For example, the mixing impeller assembly 250 can be configured as a propeller, a pitched blade assembly, a hydrofoil, a shearing disc, or combinations of these and any other appropriate form of impeller.

In some embodiments, the mixing assembly 400 can be configured to mix water and powdered additive into a substantially homogenous emulsion at a predetermined concentration. For example, a concentration of about 50 grams/liter or more in a mixing duration of less than about 25 minutes. In some embodiments, the mixing assembly 400 can be configured to mix a batch having a volume of between about 50 L and about 1500 L, 60 L and about 1200 L, or about 80 L and 900 L.

Additional mixing of the tank contents can be provided by recirculation of the mixture from the outlet 270, located near a floor 414 of the tank 240, through the recirculation conduit 272, to a recirculation manifold 472 to the collection of nozzles 274. The recirculation flow is urged by the pump 276, and is directed to the recirculation conduit 272 by closing the valve 278 and opening the valve 279. In the illustrated example, the outlet 270 includes secondary outlet 470. In some implementations, the secondary outlet 470 can be in fluid communication with an application pump configured to apply the mixture to a product (e.g., to spray the mixture on produce as a protective coating).

The mixing assembly 400 includes the turbidity sensor 273. The turbidity sensor is configured to measure the turbidity (e.g., homogeneity, consistency) of the emulsion in the tank 240. For example, the turbidity sensor can output a signal indicative of a clarity, transparency, color, etc. of the emulsion, indicating the emulsion has reached a predetermined level of mixing and/or is substantially free of large particles.

An electrical enclosure 420 houses a controller and associated electrical components (e.g., HMI, switches, circuit breakers, lockouts, air solenoids). An air compressor 430 is configured to provide air pressure for activation of the valves 278, 279, and/or 244 (e.g., by the controller) to control fluid flow into, around, and out of the tank 240.

In an example embodiment, tank 240 includes insulating characteristics to maintain a temperature of contents of the tank 240. For example, tank 240 can include a double-wall construction, and/or one or more jacket or insulating layers. Such a construction can facilitate a relatively narrow temperature range during a mixing operation. For example, the contents of tank 240 may have a first temperature (e.g., about the temperature of incoming hot water) upon filling the tank 240, and a second temperature when the contents of tank 240 are mixed and ready to be discharged from tank 240. In various example embodiments, the second temperature is greater than 50%, greater than 75%, or greater than 90% of the first temperature.

Maintaining a temperature of the contents of tank 240 can facilitate mixing and, in some embodiments, can be facilitated by us of an insulated tank without an additional heating element associated with the tank 240. In an example embodiment, the mixing assembly does not include a heating element. A tank 240, for example, that does not include a heating element can facilitate cleaning and maintenance operations of mixing assembly 400. Alternatively, some embodiments can include heating components, located internally or externally to the cavity of the tank 240, configured to provide heat to the contents of the tank 240.

The components of the mixing assembly 400 are affixed to a support structure 410 (e.g., that includes a support base 412). Other related components, such as fluid conduits, sensors, valves, pressure regulators, and other appropriate components associated with mixing, are also affixed, directly or indirectly, to the support structure 410. In some embodiments, the mixing assembly 400 can be a portable, modular assembly (e.g., a mixing skid) that can facilitate manufacture, transportation, installation, and reconfiguration at a manufacturing facilitate and/or installation location. For example, multiple powered components of the mixing assembly 400 may be connected to a single power port or cord, to provide a single point to quickly connect the mixing assembly 400 to a power bus or outlet.

In some embodiments, the mixing assembly 400 can include flow-modifying features inside the tank 240. For example, baffles, vanes, or combinations of these and other forms of flow modification features can be included to promote mixing of the contents of the tank 240 as they circulate based on the mixing impeller assembly 250.

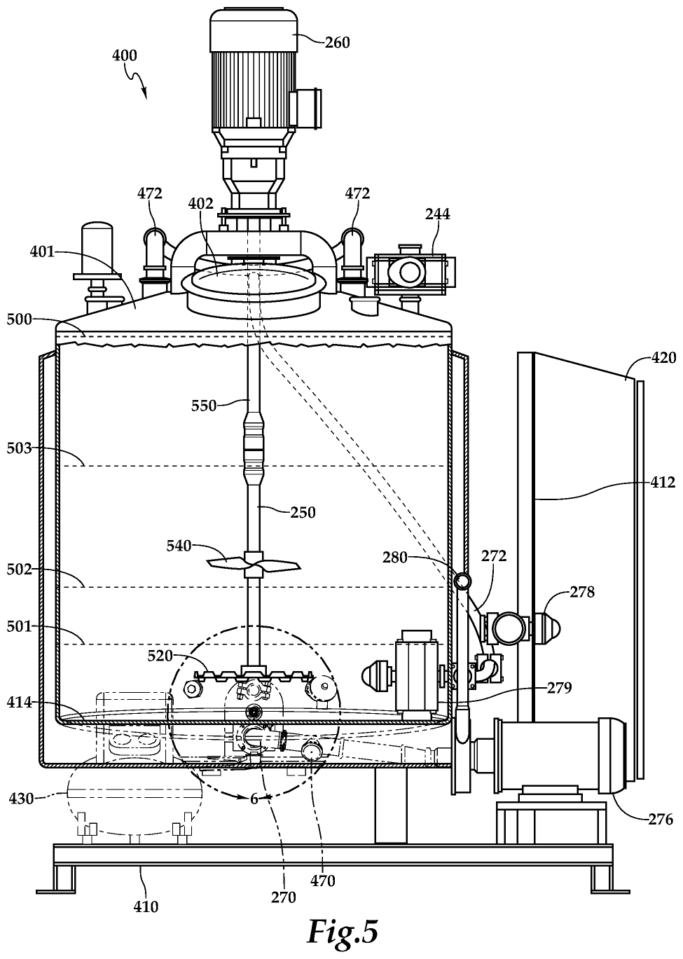

FIG. 5 shows a sectional view of the example mixing assembly 400 of FIG. 4. As described above, mixing assembly 400 includes the tank 240, the cavity 241, the valve 244, the mixing impeller assembly 250, the electric motor 260, the outlet 270, the recirculation conduit 272, the pump 276, the valve 278, the valve 279, the outlet 280, the domed lid 401, the hatch 402, the support structure 410, the support base 412, the electrical enclosure 420, and the secondary outlet 470. The tank 240 includes a floor 414 that defines a bottom of the cavity for contents of the tank 240. Floor 414 is sloped or angled such that fluid is directed toward the outlet 270 (e.g., to help define the outlet 270 as a low drain point).

In an example embodiment, the tank 240 has a total capacity of about 1350 L (356.6 gallons) when filled to a level (e.g., indicated by line 500) below a top (e.g., about 0.5 inches to about 2 inches below a top). Between the floor 414 and a level indicated by a line 501 (e.g., at a distance between about 34-40 inches below the top), the tank 240 is configured to hold about 250 L (66 gallons). Between the floor 414 and a level indicated by a line 502 (e.g., at a distance of about 25-34 inches below the top), the tank 240 is configured to hold about 473 L (125 gallons). Between the floor 414 and a level indicated by a line 503 (e.g., at a distance of about 12-20 inches below the top), the tank 240 is configured to hold about 900 L (237.8 gallons). In various example embodiments, the total capacity of the tank 240 may be between about 500 L and 3000 L, 750 L and 2000 L, or 1000 L and 1500 L. Such capacity ranges can facilitate high system throughput while predictably mixing a composition.

The mixing impeller assembly 250 includes a mixing impeller 520 and a pumping impeller 540 affixed to a rotor shaft 550. In an example embodiment, the mixing impeller 520 is configured to impart high shear to the contents of the tank 240 (e.g., to emulsify contents of the tank 240) and the pumping impeller 240 moves or turns over the contents of tank 240 to promote interaction of the entire contents of tank 240 with the mixing impeller 520. In some embodiments, the mixing impeller 520 is a high shear disc and the pumping blade 540 is a medium shear disc (e.g., configured to impart less shear than the mixing impeller 520 at a given rotational speed of the shaft 550).

The pumping impeller 540 is affixed to the rotor shaft 550 at a fixed distance relative to the mixing impeller 520. In an example embodiment, the pumping impeller 540 is separated from the mixing impeller 520 during operation by a fixed distance between about 6 inches and 36 inches, 8 inches and 24 inches, 10 inches and 14 inches, or about 12 inches. In some embodiments, the pumping impeller 540 is separated from the mixing impeller 520 by a fixed distance between about 10% and 70%, 15% and 40%, or about 33% of a height of the cavity of the tank 240 (e.g., between floor 414 and fill line 500 (FIG. 5)). In some embodiments, the pumping impeller 540 is separated from the mixing impeller 520 by a fixed distance that can be expressed as a multiple of impeller diameter.

Alternatively or additionally, during operation, the pumping impeller 540 may be positioned a fixed distance below a predetermined fill level of the tank 240. For example, during operation, the pumping impeller 540 is located a fixed distance below the line 503 (e.g., the 900 L level) between about 0 inches and 24 inches, 4 inches and 16 inches, or about 6 inches and 14 inches. In another example, the distance can be expressed as a multiple of blade diameter, for example from about 0.5× to 2.5× diameter equivalent distance from the fill level. In some examples, the position can also be expressed as a distance from the bottom of the tank 240 or the average height of the tank bottom. In some examples, the distance can be expressed as a multiple of blade diameter, for example from about 2.5× to 4× diameter equivalent distance from the bottom of the tank 240.

During operation, the mixing impeller 520 can be positioned a fixed distance below a predetermined fill level of the tank 240. In another example, the distance can be expressed as a multiple of blade diameter, for example from about a 2× to 5× diameter equivalent distance from the fill level. In some examples, the position can be expressed as a distance from the bottom of the tank 240 or an average height of the tank bottom. In some examples, the distance can be expressed as a multiple of blade diameter, for example from about 0.5× to 1× diameter equivalent distance from the bottom of the tank 240.

For example, during operation, the mixing impeller 520 is located below the pumping impeller 540, and is affixed to the rotor shaft 550 at a fixed distance below the line 501 (e.g. the 250 L level), such as between 0 inches and 6 inches, between 1 inch and 4, inches, or about 3.5 inches below the line 501. In some example embodiments, during operation the pumping impeller 540 and the mixing impeller 520 are fixed in different zones of the tank 240. For example, the mixing impeller 520 is fixed in a bottom third or quarter of the tank 240 (e.g., proximate the floor 414), and the pumping impeller 540 is located in a middle or top third or quarter of the tank 240 (e.g., not located in the bottom third or quarter of the tank 240. Such a configuration can promote complete and efficient mixing in which contents of tank 240 near floor 414 or near an upper portion of tank 240 do not settle or avoid interaction with the impellers.

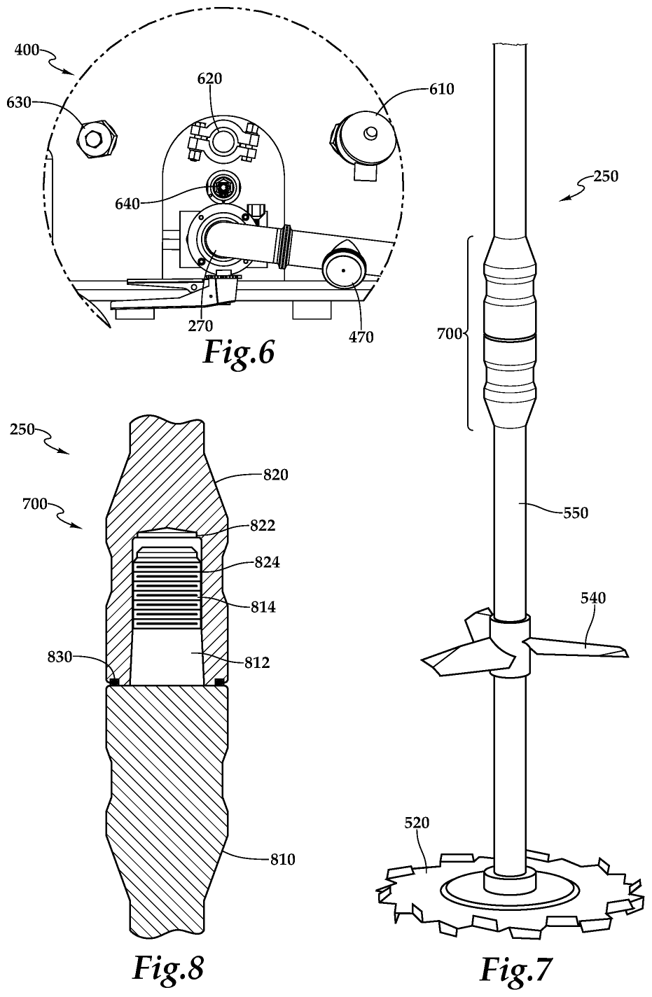

FIG. 6 shows an enlarged view of example outlet components of the mixing assembly 400. In an example embodiment, mixing assembly includes the outlet 270 and the secondary outlet 470. The outlet 270 and/or secondary outlet 270 can lead to a nozzle (e.g., arranged near a top of the tank 240), storage containers for the mixed composition, and/or an application system to apply the mixed composition to a product. In some embodiments, the mixing assembly 400 includes a temperature transmitter 610. The temperature transmitter is configured to output a signal indicative of a temperature of the contents of the tank 240 (e.g., near outlet 270/470). The temperature can be used to monitor a temperature of the contents (e.g., monitor the temperature for deviations from a predetermined range) and/or to control one or more operations of the mixing assembly 400 (e.g., maintain the temperature within a predetermined range, initiate or terminate one or more operations based on the temperature, etc.).

The mixing assembly 400 includes a turbidity sensor 620 (e.g., the turbidity sensor 273). The mixing assembly 400 also includes a capped thermowell 630. The thermowell 620 is configured as a port through which a calibrated portable temperature sensor can be inserted to verify the temperature reading from the temperature transmitter 610.

The mixing assembly 400 includes a capped pressure sensor 640. The pressure sensor 640 is configured to output a signal indicative of a pressure within the tank 240. For example, a controller can be configured to estimate the fill level of the tank 240 based on pressure sensed at the pressure sensor 640, and/or to monitor a condition of the mixing assembly 400 during operation (e.g., monitor the pressure for deviations from a predetermined range) or control one or more operations of the mixing assembly 400 (e.g., maintain the pressure within a predetermined range, initiate or terminate one or more operations based on pressure, etc.).

FIG. 7 shows an enlarged view of the example mixing impeller assembly 250. The mixing impeller assembly 250 includes the mixing impeller 520, the pumping impeller 540, and the rotor shaft 550. A coupler 700 joins portions of the mixing impeller assembly 250.

The rotor shaft 550 extends from an upper, proximal end coupled to and rotated by, directly or indirectly, the motor 260. The rotor shaft 550 has a predetermined length configured to position the mixing impeller 520 and pumping impeller 540 in a fixed location within the tank 240 during operation of the mixing assembly 400. In some embodiments, the rotor shaft 550 can extend between 50% and 98%, 70% and 95%, or 75% and 90% of a height of the cavity of the tank 240 (e.g. between floor 414 and fill line 500 (FIG. 5)). In an example embodiment, the shaft has a cylindrical shape and a diameter between about 0.5 inches and 2.5 inches, 1 inch and 2 inches, or about 1.5 inches. Such a configuration can provide a robust mixing impeller assembly 250 that locates the impellers in prospective positions within the tank 240 to promote consistent and efficient mixing. In some embodiments, the spacing between the impellers can be determined based on the impellers' diameters. For example, the distance between the two impellers can be approximately 2× the impeller diameter.

The mixing impeller 520 is arranged at or near a second, distal end of the rotor shaft 550. The mixing impeller 520 has a diameter of about 6 inches to 36 inches, 12 inches to 24 inches, 14 inches to 18 inches, or about 16 inches. In some embodiments, the mixing impeller diameter is between about 10% and 80%, 15% and 60%, 20% and 50%, or about 30% of an inner diameter of tank 240 (e.g., at a height where the mixing impeller 520 is located during operation. Such relative dimensions can facilitate efficient and predictable agitation of the contents of the tank 240, imparting a predetermined shear force at a given rotational speed.

The mixing impeller 520 is configured as a high shear disc that imparts a relatively high shear on the contents of the tank 240. For example, the mixing impeller can include a sawtooth impeller that generates high shear levels. In an example embodiment, the mixing impeller 520 includes an axial portion that extends outwardly from the shaft 550, and a plurality of radially-extending teeth or blades located around a perimeter. The teeth extend in opposed (e.g., alternating upwardly and downwardly extending directions). The pumping impeller 540 is arranged at a predetermined position along the rotor shaft 550, at a predetermined distance from the mixing impeller 520, during operation. The pumping impeller 540 is configured to turn over the tank to reduce or eliminate dead zones. In various example embodiments, the pumping impeller is configured to provide more than 30, more than 50, or more than 70 turnovers per minute of contents of the tank 240 (e.g., at a impeller rotational speed between about 300 and about 5000 revolutions per minute). In an example embodiment, the pumping impeller 540 includes a propeller shape having a plurality of blades (e.g., three blades) and a total diameter between about 6 inches to 36 inches, 10 inches to 18 inches, or about 12 inches. For example, the pumping impeller 540 has a shape and configuration that is different than the shape and configuration of the mixing impeller 520 (e.g., a three-blade propeller vs. a high-shear disc with axial teeth). In some embodiments, the pumping impeller diameter is between about 10% and 80%, 15% and 60%, 20% and 50%, or about 30% of an inner diameter of tank 240 (e.g., at a height where the pumping impeller 540 is located during operation).

During operation, rotation of shaft 550 and the speed of the mixing impeller 520 and the pumping impeller 540, is controlled to impart predetermined energy to the contents of the tank 240. In an example embodiment, the shaft 550 is rotated between 300 RPM and 5000 RPM, 400 RPM and 2000 RPM, or 500 RPM and 1500 RPMs. For example, the shaft 550 can be rotated at about 630 RPM. The mixing impeller 520 and pumping impeller 540 can be configured to have a predetermined tip speed (e.g., at an outer perimeter location). In various example embodiments, the mixing assembly 400 is controlled to generate a mixing impeller tip speed between about 5 m/s and 20 m/s, 6 m/s and 15 m/s, or about 8 m/s (e.g., at 300 to 5000 RPMs).

FIG. 8 shows a sectional view of the coupler 700 of the example mixing impeller assembly 250. The rotor shaft 550 is configured as split shaft having a first section 810 comprising an axially threaded male portion 812 having a first thread 814, and a second section 820 comprising a female portion 822 having a second thread 824 configured to threadedly mate with the first thread 814 such that the first thread 814 is entirely concealed within the second section 820. A seal 830 is arranged in sealing contact between the first section 810 and the second section 820, and is configured to prevent incursion of emulsion into the threads 814, 824 (e.g., to prevent corrosion, to prevent cross-contamination between successive batches).

The mixing assembly 100 facilitates efficient and predictable mixing of a composition, such as a coating composition to be applied to products. In various example embodiments, the mixing assembly 100 imparts sufficient shear to efficiently and predictably prepare a composition that includes a monoglyceride and a fatty acid salt. In some embodiments, the monoglyceride can be present in the mixture in an amount of about 50% to about 99% by mass in a powder mixture, or about 5% in a water mixture. In some embodiment, the monoglyceride can be present in the coating mixture in an amount of about 90% to about 99% by mass. In some embodiments, the monoglyceride can be present in the coating mixture in an amount of about 95% by mass (dry). In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating mixture in an amount of about 1% to about 50% by mass. In some embodiments, the fatty acid salt can be present in the coating mixture in amount of about 1% to about 10% by mass. In some embodiments, the fatty acid salt can be present in the coating mixture in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating mixture further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating mixture has a concentration of about 1 g/L to about 50 g/L (e.g., when the completed mixture is prepared for discharge from the mixing assembly 400).

The heated solvent to which the coating agent and wetting agent (when separate from the coating agent) is added within the tank 240 can, for example, be water, methanol, ethanol, isopropanol, butanol, acetone, ethyl acetate, chloroform, acetonitrile, tetrahydrofuran, diethyl ether, methyl tert-butyl ether, an alcohol, a combination thereof, etc. The resulting solutions, suspensions, or colloids can be suitable for forming coatings on products.

In various example embodiments, coatings described herein can be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by mass or by volume. In some implementations, the solvent includes a combination of water and ethanol, and can optionally be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by volume. In some implementations, the solvent or solution/suspension/colloid can be about 40% to 100% water by mass or volume, about 40% to 99% water by mass or volume, about 40% to 95% water by mass or volume, about 40% to 90% water by mass or volume, about 40% to 85% water by mass or volume, about 40% to 80% water by mass or volume, about 50% to 100% water by mass or volume, about 50% to 99% water by mass or volume, about 50% to 95% water by mass or volume, about 50% to 90% water by mass or volume, about 50% to 85% water by mass or volume, about 50% to 80% water by mass or volume, about 60% to 100% water by mass or volume, about 60% to 99% water by mass or volume, about 60% to 95% water by mass or volume, about 60% to 90% water by mass or volume, about 60% to 85% water by mass or volume, about 60% to 80% water by mass or volume, about 70% to 100% water by mass or volume, about 70% to 99% water by mass or volume, about 70% to 95% water by mass or volume, about 70% to 90% water by mass or volume, about 70% to 85% water by mass or volume, about 80% to 100% water by mass or volume, about 80% to 99% water by mass or volume, about 80% to 97% water by mass or volume, about 80% to 95% water by mass or volume, about 80% to 93% water by mass or volume, about 80% to 90% water by mass or volume, about 85% to 100% water by mass or volume, about 85% to 99% water by mass or volume, about 85% to 97% water by mass or volume, about 85% to 95% water by mass or volume, about 90% to 100% water by mass or volume, about 90% to 99% water by mass or volume, about 90% to 98% water by mass or volume, or about 90% to 97% water by mass or volume.

Coating agents formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance of the coatings.

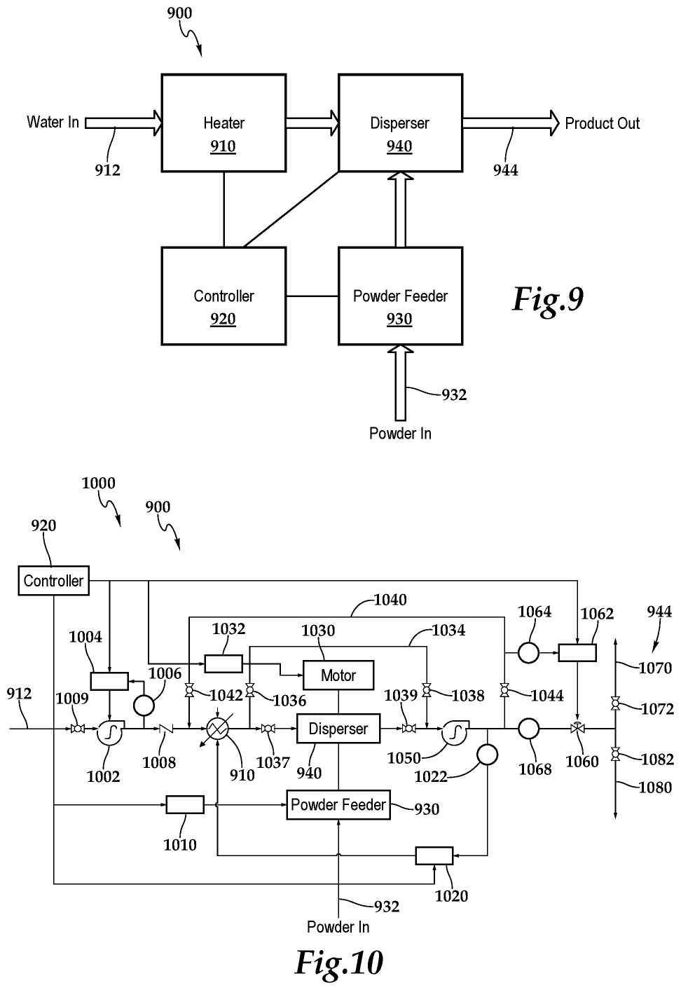

FIG. 9 shows a block diagram of an example system 900 for continuous industrial mixing. The system 900 includes a heating assembly 910 that is configured to heat water received from a water source 912 (e.g., a water tap, a filtration or other processing system). In some embodiments, the heating assembly 910 can include one or more features of the example heating assembly 300 of FIGS. 1-3B. The heating assembly 910 is controlled by a controller 920 (e.g., to control the amount of heating applied, to measure water output temperature, to measure and/or control water flow, etc.).

The system 900 includes a powder feeder 930 (e.g., an auger assembly configured to provide a powder). The powder feeder 930 is configured to urge movement of an additive from a source 932 (e.g., a bin, hopper, tote) to an inline high shear disperser 940.

The disperser 940 is configured to receive heated water from the heating assembly 910 and powered additive from the powder feeder 930, and mix the water and powder into an emulsion that is provided at a product outlet 944. The disperser 940 is controlled and monitored by the controller 920 (e.g., mixing speed, turbidity sensing, output flow).

The system 900 is configured to operate substantially continuously (e.g., as opposed to producing the emulsion in batches). In some embodiments, the system 900 can mix the powder and water into a substantially homogenous emulsion at a predetermined concentration. In an example embodiment, the disperser 940 includes one or more high shear disc components that facilitate delivery of the substantially homogeneous emulsion at a concentration of about 1 g/L to about 50 g/L at an output rate of between 10 L/min and 100 L/min, 15 L/min and 50 L/min, or about 20 L/min.

FIG. 10 shows a schematic diagram 1000 of the example system 900 for continuous industrial mixing, including the heating assembly 910, the water source 912, the controller 920, the powder feeder 930, the disperser 940, and the product outlet 944.

A pump 1002 controls water flow rate through the system 900. The speed of the pump 1002 is controlled by a feedback loop controller 1004 based on a setpoint from the controller 920 and a feedback signal from a flow indicator 1006. Fluid backflow is prevented by a check valve 1008. A valve 1009 is configured to controllably stop and allow water flow from the water source 912 to the pump 1002.

The powder feeder 930 is controlled by a feed-forward controller 1010 based on a flow setpoint from the controller 920. The heating assembly 910 is controlled by a temperature controller 1020, based on temperature feedback from a temperature sensor 1022 and a setpoint from the controller 920.

The disperser 940 is driven by a motor 1030 (e.g., a variable frequency drive, VFD) controlled by a feed-forward controller 1032 based on a setpoint from the controller 920. A bypass conduit 1034 provides a fluid path around the disperser 940 that can be used by selectably configuring a collection of valves 1036-1039.

A recirculation conduit 1040 is configured to fluidically connect the output of the disperser to the inlet of the heating assembly 910. A valve 1042 and a valve 1044 are configured to selectably permit full, partial, or zero flow through the recirculation conduit 1040. A pump 1050 is configured to urge flow of fluid output by the disperser 940.

A valve 1060 is configured to provide full, partial, or zero flow restriction from the pump 1050 to the product outlet 944. The valve 1060 is controlled by a flow controller 1062 based on a flow rate sensed by a flow indicator 1064 and a set point from the controller 920. When the valve 1060 is at least partly closed and the valves 1042 and 1044 are open, the pump 1050 can urge a recirculating flow through the recirculation conduit 1040.

A conductivity indicator and recorder (CIR) 1068 is arranged in the flow between the pump 1050 and the valve 1060. The CIR 1068 is configured to calculate the concentration based on the measured conductivity of the mixture (e.g., grams of powder per liter of water).

The product outlet 944 includes a production outlet 1070 and a drain outlet 1080. Flow to the production outlet 1070 is controlled by a valve 1072, and flow to the drain outlet 1080 is controlled by a valve 1082. In some implementations, the production outlet 1070 can be fluidically connected to one or more product applicators (e.g., sprayers). In some implementations, the drain outlet 1080 can direct flow to a drain or waste reclamation system (e.g., to clean, flush, or empty the system 900).

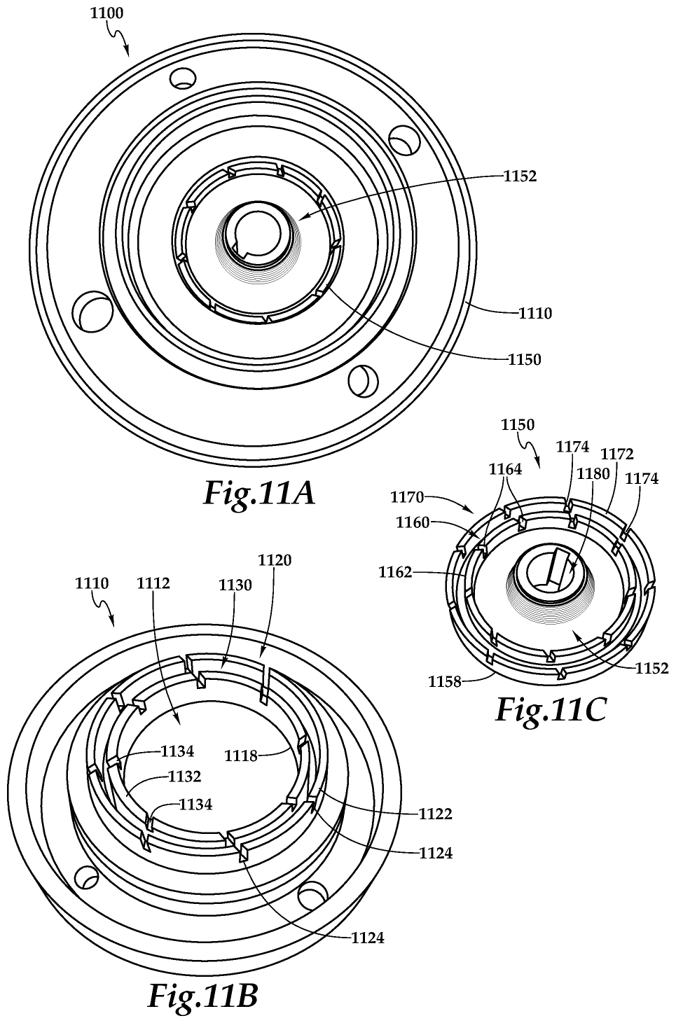

FIGS. 11A-11C show assembled (FIG. 11A) and disassembled views (FIGS. 11B-11C) of an example mixing impeller assembly 1100 for continuous industrial mixing. In some implementations, the mixing impeller assembly can be part of the example disperser 940 of FIGS. 9 and 10. Mixing impeller assembly 1100 includes a stator 1110 and a rotor 1150.

Referring to FIG. 11B, the stator 1110 has an axial cavity 1112 defined therethrough, and has a first ring of teeth 1120 and a second ring of teeth 1130 arranged concentrically about a periphery 1118 of the cavity 1112. The teeth 1120 are formed as a ring 1122 having a collection of narrow slots 1124. The slots 1124 are formed with a mildly spiral or helically radial orientation relative to the axis of the ring 1122. The ring of teeth 1130 are formed as a ring 1132 arranged proximal to and concentrically within the ring 1122. The ring 1132 has a collection of narrow slots 1134. The slots 1134 are formed with a mildly spiral or helically radial orientation relative to the axis of the ring 1132.

Referring to FIG. 11C, the rotor 1150 has a ring of teeth 1160 and another ring of teeth 1170 arranged concentrically about an outer periphery 1158 of the rotor 1150. The teeth 1160 are formed as a ring 1162 having a collection of narrow slots 1164. The slots 1164 are formed with a mildly spiral or helically radial orientation relative to the axis of the ring 1162. The ring of teeth 1170 are formed as a ring 1172 arranged proximal to and concentrically within the ring 1162. The ring 1172 has a collection of narrow slots 1174. The slots 1174 are formed with a mildly spiral or helically radial orientation relative to the axis of the ring 1162. The rotor 1150 also includes a bore 1180 that is configured to mate with a rotor shaft (not shown) to urge rotation of the rotor 1150 concentrically within the cavity 1112 of the stator 1110.

Referring to FIG. 11A, when assembled, the teeth 1170 are arranged concentrically and in close proximity to the teeth 1130. In use the rotor 1150 is rotated concentrically within cavity 1112 of, and relative to, the stator 1110. Water and powered additive is pumped or otherwise provided to an interior cavity 1152, within the ring 1162. The pumping and the rotation of the rotor 1150 relative to the stator 1110 causes the substantially unmixed water and powder to be urged through the slots 1174 and 1164 between the teeth 1170 and 1160, then through the slots 1124 and 1134.

The motion of the rotor 1150 relative to the stator 1110 creates a shearing action to mix the water and powder into an emulsion. Shear forces in the gaps between the teeth 1120, 1130, 1160, and 1170 break up the powder and allow wetting of the particles. Turbulent flow between the teeth 1120, 1130, 1160, and 1170 mixes the fluid and powder and enhance or urge the dissolution and melting of the solid, and breakup of immiscible liquid melt droplets. In some embodiments, the shear generated by the mixing impeller assembly can be characterized by the following equations:

Shear stress has units of pressure F/A:

$$τ = μ du / dy$$

The power law

$$τ = {K ( \frac{d u}{d y} )}^{n}$$

is a more general equation, where n=1 and K=μ for Newtonian fluids.

Normalizing by the viscosity of the fluid makes the design fluid-independent. This can be defined as “shear rate” and can be given by the equation:

$$S R = τ / μ = du / dy = v / t$$

Where ν is the velocity, and t is the thickness of the gap between the rotor 1150 and the stator 1110 (SR has units [s⁻¹]). Multiplying the residence time (Tᵢ) of fluid in the stage i by the shear rate (SRᵢ) gives a dimensionless quantity SN:

$$S {N}_{i} = {T}_{i} S {R}_{i}$$

Adding this quantity over all the stages gives the shear exposure per flow RT and SR are calculated based on the dimensions of the shear stages.

$$S N = \frac{1}{F} {π}^{2} f {\sum }_{i} {h}_{i} {D}_{i}^{2}$$

Where:

hᵢ is the height of the stage [m],

f is the rotation frequency [s⁻¹],

Dᵢ is the diameter of the stage [m], and

F is the flow rate [m³s⁻¹]

As flowrate increases, the same shear exposure can be achieved by adding more stages, or increasing the dimensions (hᵢ & Dᵢ). SN is independent of the gap thickness since it is used to calculate the volume and the shear rate. SN calculation is sufficient so long as the Reynolds Number is maintained such that flow in the gap is laminar.

The work required for shear stress in the high shear laminar gap can be calculated by W≐τAu (force times velocity):

$$P = {π}^{3} μ {f}^{2} {\sum }_{i} \frac{{h}_{i}}{{t}_{i}} {D}^{{i}^{3}}$$

Where:

hᵢ is the height of the stage [m],

f is the rotation frequency [s⁻¹],

Dᵢ is the diameter of the stage [m],

t is the gap thickness [m], and

μ is the viscosity [Pa s].

The water and powder emerges from the slots 1124 as an emulsion that can flow to downstream processes (e.g., the recirculation conduit 1040, the product outlet 944).

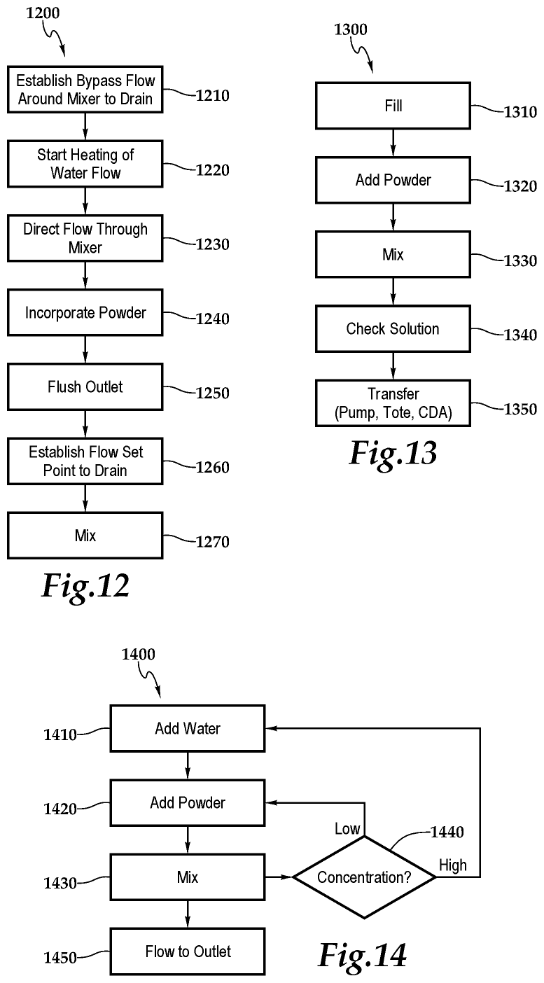

FIG. 12 is a flow diagram of an example startup process 1200 for a system for industrial mixing. In some implementations, the process 1200 can be performed by the example system 100 of FIG. 1 or the example system 900 of FIG. 9.

At 1210, a bypass flow is established around the mixing assembly to a drain. For example, the bypass conduit 245 can be engaged to flow fluid around the tank 240 to the outlet 270, and the outlet 280 can be directed to the drain 142.

At 1220, heating of a water flow through the bypass is started. For example, the heater assembly 300 can be turned on to heat water flowing to the mixing assembly 400.

At 1230, flow is directed through the mixing assembly 400. For example, the bypass conduit 245 can be closed off to route flow of the heated water to the tank 240.

At 1240, powdered additive is added to the heated water. For example, the hatch 402 can be opened and a predetermined amount of powdered additive can be poured into the tank 240. In another example, the powder feeder 930 can be activated to urge powder into the disperser 940.

At 1250, an outlet is flushed. For example, the tank 240 can be partly drained through the outlet 140 to flush out any bypass water that might remain that could potentially dilute the emulsion product.

At 1260, a flow set point to drain is established. For example, flow can be directed back to the drain 142.

At 1270, mixing is started. For example, the motor 260 can be started to rotate the mixing impeller assembly 250.

FIG. 13 is a flow diagram of an example batch mixing process 1300 for a system for industrial mixing. In some implementations, the process 1300 can be performed by the example system 100 of FIG. 1. In some implementations, the process 1300 can be performed after the process 1200.

At 1310, a tank is filled. For example, the tank 240 of the mixing assembly 400 can be filled with hot water from the heater assembly 300.

At 1320, powdered additive is added. For example, the hatch 402 can be opened and a predetermined amount of powdered additive can be poured into the tank 240.

At 1330, the contents of the tank are mixed. For example, the mixing impeller assembly 250 can be rotated to mix the powder and water into an emulsion.

At 1340, the solution in the tank is checked. For example, a turbidity sensor can be used to determine the density and consistency of the emulsion being mixed in the tank 240.

At 1350, the contents of the tank are transferred. For example, the tank 240 can be pumped or drained into a liquid tote for transport to a point of use. In another example, the tank can be fluidically connected to a conduit that can transport the emulsion to a product bath or sprayer. In some implementations, the determination of when to perform the transfer step 1350 can be based on the determination of step 1340 (e.g., transfer can be performed once a predetermined concentration and homogeneity have been reached). In some implementations, the determination of when to perform the transfer step 1350 can be based on time and past data about the process 1300 (e.g., transfer can be performed after a predetermined duration of mixing).

FIG. 14 is a flow diagram of an example continuous mixing process 1400 for a system for industrial mixing. In some implementations, the process 1400 can be performed by the example system 900 of FIG. 9. In some implementations, the process 1300 can be performed after the process 1200.

At 1410, water is provided. For example, hot water from the heating assembly 910 can be provided to the disperser 940.

At 1420, powdered additive is provided. For example, the powder feeder 930 can be activated to urge powdered additive into the disperser 940.

At 1430, the water and powdered additive are mixed. For example, the disperser 940 can be activated to mix the hot water and powdered additive into an emulsion.

At 1440, a determination about the emulsion concentration is made. For example, a turbidity sensor or the CIR 1068 can be used to measure the concentration of the emulsion. If the concentration is too high, then relatively more hot water can be added at 1410. In some implementations, the concentration can be reduced by slowing the rate at which the powder feeder 930 operates and/or by increasing the water flow rate. If the concentration is too low, then relatively more powdered additive can be added at 1420. In some implementations, the concentration can be raised by increasing the rate at which the powder feeder 930 operates and/or by decreasing the water flow rate.

At 1450, the resulting emulsion is flowed to an outlet. For example, the flow through the disperser 940 can be directed to the product outlet 944.

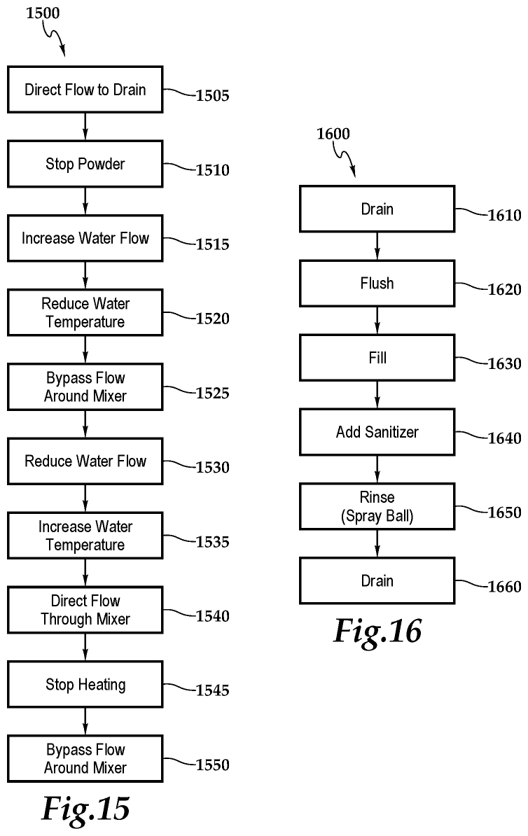

FIG. 15 is a flow diagram of an example shutdown process 1500 for a system for industrial mixing. In some implementations, the process 1500 can be performed by the example system 100 of FIG. 1 or the example system 900 of FIG. 9. In some implementations, the process 1500 can be performed after the example processes 1300 and/or 1400.

At 1505, flow is directed to a drain. For example, the flow of emulsion from the outlet 280 can be directed away from the outlet 140 and to the drain 142.

At 1510, the addition of powdered additive is stopped. In some implementations, this can be a manual step in which no more powder is added through the hatch 402. In some implementations, this can be an automated step in which the powder feeder 930 is stopped.

At 1515, water flow is increased. For example, the flow rate from the heater assembly 300 can be increased from about 3 L per minute to about 5.7 L per minute. At 1520, the water temperature is decreased. For example, the heater assembly 300 can be set to provide water at a temperature of about 50 degrees C.

At 1525, flow is bypassed around the tank. For example, water flow can be redirected around the tank 240 through the bypass conduit 245.

At 1530, water flow is reduced. For example, the flow rate from the heater assembly 300 can be reduced to about 2.8 L per minute. At 1535, water temperature is increased. For example, the heater assembly 300 can be set to provide water at a temperature of about 85 degrees C.

At 1540, water flow is redirected through the tank. For example, water flow through the bypass conduit 245 can be redirected to the tank 240.

At 1545, heating is stopped. For example, the heating assembly 300 can be configured to provide no additional heating to the water flow, or it can be switched off.

At 1550, the tank is bypassed again. For example, the unheated water flow can be re-routed around the tank through the bypass conduit 245 (e.g., to the drain). In some implementations, cool water can be flowed to speed the cooling of components of the system 100 (e.g., prior to performing mechanical maintenance to avoid burns or injury to human operators).

FIG. 16 is a flow diagram of an example cleaning process 1600 for a system for industrial mixing. In some implementations, the process 1600 can be performed by the example system 100 of FIG. 1 or the example system 900 of FIG. 9. In some implementations, the process 1500 can be performed after the example processes 1300 and/or 1400.

At 1610, the mixer is drained. For example, the tank 240 or the system 900 can be emptied to the drain 142.

At 1620, the mixer is flushed. For example, clean water can be flowed through the tank 240 or the disperser 940.

At 1630, the mixer is at least partly filled. For example, the tank 240 can be filled with water, or the disperser 940 can be substantially purged of air.

At 1640, a sanitizer is added. For example a sanitizer such as peracetic acid or a chlorine solution can be added to the tank 240 (e.g., through the hatch 402) or injected into the flow path of the disperser 940. In some implementations, various components of the system can be operated in order to sanitize them. For example, the pump 276 can be engaged to flow the sanitizer solution through the recirculation conduit 272 and the recirculation manifold 472.

At 1650, rinsing is performed. For example, a spray ball can be inserted into the tank 240 to irrigate the domed lid 401 and other internal surfaces of the tank 240. In another example, additional fresh water can be flowed through the tank 240 or the disperser 940.

At 1660, the system is drained. For example, the contents of the tank 240 or the disperser can be emptied to the drain 142 or the drain outlet 1080.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A mixing system comprising:
a heating assembly configured to heat liquid; and,
a mixing assembly comprising:
a tank defining a cavity configured to retain liquid;
an inlet in fluidic communication with the cavity and configured to receive liquid from the heating assembly;
a mixing impeller assembly configured to mix contents of the cavity;
an actuator configured to actuate the mixing impeller assembly to mix contents of the cavity; and
an outlet in fluidic communication with the cavity and having a valve configured to selectively prevent and permit egress of contents of the cavity.

2. The mixing system of claim 1, wherein the mixing impeller is located below a pumping impeller.

3. The mixing system of claim 2, wherein the mixing impeller is configured to generate relatively higher shear than the pumping impeller during operation.

4. The mixing system of claim 2, wherein the mixing impeller has a mixing impeller diameter and the tank has a tank inner diameter, and the mixing impeller diameter is between 10% and 80% of the tank inner diameter.

5. The mixing system of claim 4, wherein the mixing impeller comprises a high shear disc.

6. The mixing system of claim 4, wherein the tank inner diameter is measured at a height of the mixing impeller.

7. The mixing system of claim 1, wherein the mixing impeller assembly comprises a rotor shaft, a pumping impeller configured to be rotated by the rotor shaft, and a mixing impeller configured to be rotated by the rotor shaft.

8. The mixing system of claim 7, comprising a rotor shaft that includes a first section comprising an axially threaded male portion having a first thread, and a second section comprising a female portion having a second thread configured to threadedly mate with the first thread such that the first thread is entirely concealed within the second section.

9. The mixing system of claim 1, further comprising at least one of:
a temperature sensor configured to measure temperature of contents of the cavity;
a turbidity sensor configured to measure turbidity of contents of the cavity; and
a pressure sensor configured to measure a pressure of the cavity.

10. The mixing system of claim 1, wherein the mixing assembly further comprises an access port configured to provide access to the cavity.

11. A method of mixing, comprising:
at least partly filling a tank with a liquid;
adding a powdered additive to the liquid through an access port of the tank; and
mixing the powdered additive into the liquid to form an emulsion.

12. The method of claim 11, further comprising;
determining a level of homogenization of the emulsion; and
terminating the mixing, based on the level.

13. The method of claim 12, further comprising:
determining a level of homogenization of the emulsion; and,
removing, based on the level, at least a portion of the emulsion from the tank.

14. The method of claim 12, further comprising heating, by a heating assembly, the liquid before at least partly filling the tank through an inlet in fluidic communication with the tank.

15. The method of claim 12, wherein mixing the powdered additive into the liquid to form a slurry comprises mixing, by a mixing impeller assembly comprising a rotor shaft, a pumping impeller configured to be rotated by the rotor shaft, and a mixing impeller configured to be rotated by the rotor shaft.

16. The method of claim 15, wherein the mixing impeller is located below the pumping impeller.

17. The method of claim 16, wherein the mixing impeller comprises a high shear disc that includes axially-extending teeth arranged around a perimeter of the mixing impeller.

18. The method of claim 15, further comprising assembling a first section to a second section to form the rotor shaft, wherein the rotor shaft is configured as split shaft, the first section comprises an axially threaded male portion having a first thread, and the second section comprises a female portion having a second thread configured to threadedly mate with the first thread such that the first thread is entirely concealed within the second section.

19. The method of claim 14, wherein mixing the powdered additive into the liquid to form an emulsion further comprises rotating a high shear disc.

20. A mixing assembly comprising:
a liquid inlet;
a powder inlet;
an outlet;
a heating assembly configured to heat liquid received through the liquid inlet;
a powder feeder configured to urge movement of a powdered additive received through the powder inlet;
a disperser assembly configured to mix the powdered additive from the powder feeder and liquid received from the heating assembly into an emulsion; and
a controller configured to control the heating assembly to heat liquid by a predetermined amount at a predetermined flow rate, control the powder feeder to provide the powdered additive to the dispenser assembly at a predetermined rate, and control the disperser assembly to provide the emulsion at a predetermined concentration at a predetermined flow rate.

21. The mixing assembly of claim 20, further comprising a flow regulator configured to regulate fluid flow through the liquid inlet or the outlet at a predetermined flow rate.

22. The mixing assembly of claim 20, wherein the mixing assembly does not include a mixing tank.

23. The mixing assembly of claim 20, wherein the disperser assembly comprises:
a stator having an axial cavity defined therethrough, and having a plurality of first teeth arranged concentrically about a periphery of the cavity; and
a rotor arranged concentrically within the cavity and having a plurality of second teeth arranged about an outer periphery of the rotor proximal the first teeth;
wherein the rotor is configured to rotate within the cavity relative to the stator, and emulsify the powdered additive and liquid received within a radial interior of the rotor as the powdered additive and liquid are urged through the second teeth and the first teeth.

24. A method of mixing, comprising:
providing a liquid at a predetermined liquid flow rate;
heating the liquid to a predetermined temperature;
providing a powdered additive at a predetermined powder flow rate;
dispersing the powdered additive into the heated liquid to form an emulsion having a predetermined concentration; and
providing the emulsion at a predetermined output rate.

25. The method of claim 24, wherein the liquid flow rate is between 10 L/min and 360 L/min, the predetermined temperature is between 50° C. and 100° C., the powder flow rate is between 10 g/min and 18,000 g/min, the predetermined concentration is between 1 g/L and 50 g/L, and the predetermined output rate is between 10 L/min and 360 L/min.
